(19) United States
(12) Patent Application Publication
(10) Pub. No.: US 2006/0064869 A1
(43) Pub. Date: Mar. 30, 2006

(54) Tool holder

(76) Inventor: Terry J. Shipper, Justice, IL (US)

Correspondence Address: BARNES & THORNBURG, LLP, P.O. BOX 2786, CHICAGO, IL, 60690-2786, US

(21) Appl. No.: 10/950,933

(22) Filed: Sep. 27, 2004

(51) Int. Cl. B23P 19/00; B23C 3/00

(52) U.S. Cl. 29/700; 409/234; 409/131

(57) ABSTRACT

A tool holder device. The tool holder comprises a shank having a first shank portion and a second shank portion. The tool holder also comprises an end component having a first component portion and a second component portion. An expansion member is configured to surround the first shank portion and the first component portion wherein the expansion member expands as the shank is engaged with the end component. Additionally, a method of fastening a tool comprises positioning an expansion member around a shank and positioning an end component partially within the expansion member. Next the end component is connected to the shank wherein the shank is inserted within a spindle bore. Then, the expansion member is expanded against the spindle bore to secure the shank within the spindle bore.

### BACKGROUND OF THE INVENTION

The present invention relates to a tool holder. In particular, the present invention relates to an automotive tool holder and method of using an automotive tool holder wherein the automotive tool holder reduces run out of a tool.

In a high speed machining process, an automotive adaptor is used to adapt “automotive-shank” tool holders to tooling machines which employ a center use process such as a rotating spindle. For high speed machines, centrifugal force of the rotating spindle has a significant impact on the tool processing a work piece. Thus, the tool holder becomes an important component to successful machining.

An automotive shank tool holder consists of a chuck end to hold the tool and a shank end to connect with the spindle. The chuck end typically has a collet for securing the tool, such as a drill, reamer or the like, coaxially to the chuck end. The shank end, in turn, includes an elongated shank which is inserted into a receiving bore on the rotatably driven spindle, wherein the spindle bore rotates coaxial with the axis of rotation of the spindle. Accordingly, the tool secured by the collet to the chuck end rotates hypothetically coaxial with the axis of rotation of the spindle. The shank end of the tool holder also includes threads and a Woodruff key for locating and driving the shank end within the spindle bore. The threads are used to set the desired length that the automotive-shank tool holder can be inserted into the spindle bore by adjusting a collar that travels along the threads.

Integral in machining the work piece is removing the material of the work piece in a controlled manner. Maintaining a smooth and consistent rotation of the tool along the center line of the axis of rotation of the spindle becomes important. Accordingly, the shank end must be properly inserted within the spindle bore. Typical tool holders are configured wherein both the spindle bore as well as the shank end are cylindrical in shape and are simply machined to sufficiently close tolerances to ensure that the axis of the shank end is nearly coaxial with the axis of the spindle. Other typical tool holders configure the spindle bore and the shank end in cooperating engagement pieces.

Once the shank end is inserted into the spindle bore, the shank end must be secured within the spindle bore. In a method of securing the shank end to the spindle bore, referring to FIG. 1, a set screw 26 is tightened against a whistle flat on the shank end shifting the shank end off-center of the spindle axis 28. Consequently, the two axes run coaxially, but shifted to an eccentric condition 32 causing the shank and cutting tool held in the chuck end to cut ineffectively. Additionally, woodruff key 11 extends from shank end 12 into a key slot or spindle keyway 17 extending axially in the interior wall 18 of spindle 20.

A problem with typical tool holder spindles 10, though, is that the shank end 12 is moved off-center within the spindle bore 14 during rotation. Typical tool holders 10 use a set screw 26 inserted through the spindle bore 14, which passes through the gap 16 between the interior wall 18, to contact the shank end whistle flat 12. The set screw 26 can then be tightened against the shank end 12 to hold the shank end 12 against the interior wall 18. The force of the set screw 26, however, offsets the shank end 12 within the interior of the spindle bore 14. In other words, the set screw 26 pushes the shank end 12 off center causing eccentric run out of the tool holder 10, the run out being defined as the deviation of the eccentric spin of the shank end 12. Thus, there is a differential of the diameter of the spindle bore 14 and the outside diameter of the shank end 12. Accordingly, a center line 28 of the shank end 12 is configured in an eccentric offset 30 with respect to the center line 32 of the spindle bore 14. This eccentric offset 30 creates the run out of the tool 22 which leads to a poor quality interface between the tool 22 and work piece 24 reducing the efficiency and output of the tool holder 10.

Efficient and economic cutting processes are crucial for machining systems. As such, machining systems require tools which process the work piece with maximum but controlled contact with the work piece. Additionally, machining systems require that the tool rotates consistently along the axis of rotation of the spindle. Accordingly, a need exists for tool holder that tightly fits the tool within the spindle bore. The solution, however, must not offset the tool holder within the spindle bore. Additionally, the solution must rotate the tool along the axis of rotation of the spindle while providing controlled contact between the tool and the work piece to provide superior balance and harmonic properties. Thus, the solution must prevent run out of the tool.

### BRIEF DESCRIPTION OF THE DRAWINGS

FIG. 1 illustrates in side elevation view a traditional prior art adapter;

FIG. 1A is an end view of the adapter of FIG. 1, taken along line 1A-1A.

FIG. 2 illustrates in a side elevation view elements of the tool holder device of the present invention;

FIG. 3 illustrates a side elevation view of an end component of the present invention;

FIG. 4 illustrates a partial cross-sectional end view of the end component FIG. 3;

FIG. 5 illustrates a side elevation cross-sectional view of the expansion member of the present invention;

FIG. 6 illustrates a cross-sectional view of the expansion member of FIG. 5; and

FIG. 7 illustrates a side elevation view of an embodiment of the assembled tool holder device of the present invention.

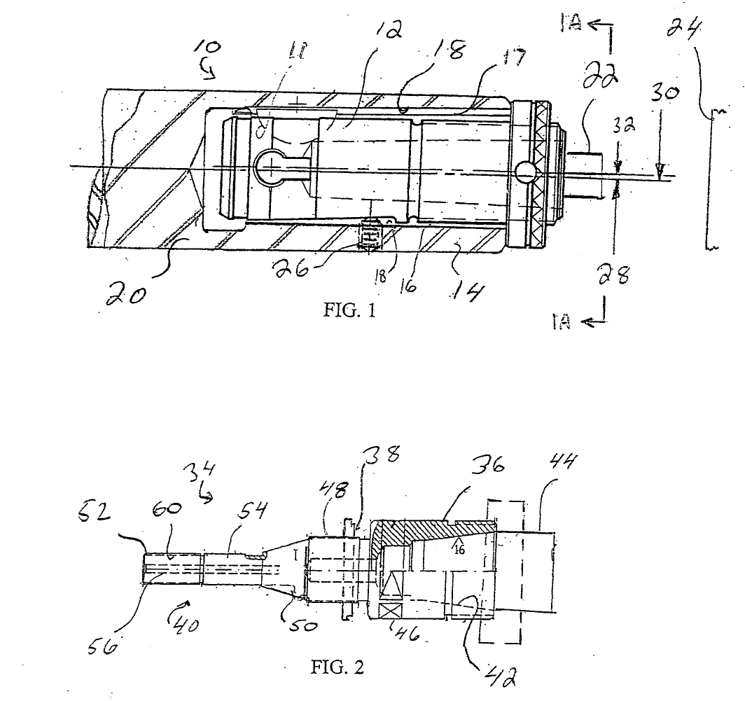

### SUMMARY OF THE INVENTION

The present invention comprises a tool holder including a shank having a first shank portion and a second shank portion. The tool holder also comprises an end component having a first component portion and a second component portion. An expansion member is configured to surround the first shank portion and the first component portion, wherein the expansion member expands as the shank is engaged with the end component.

In an embodiment of the invention, the first shank portion and the first component portion are conical shaped, wherein the first shank portion and the first component portion taper toward the body. Additionally, in an embodiment, the expansion member comprises a first expansion portion and the second expansion portion which are conical shaped tapering toward each other. In an embodiment, the first shank portion nests within the first expansion portion while the first component portion nests within the second expansion portion of the expansion member.

The present invention also relates to a method of fastening a tool. In the method, an expansion member is positioned around a shank and an end component is partially positioned within the expansion member. The end component is connected to the shank wherein the shank is inserted within a spindle bore. An expansion member is expanded against the spindle bore to secure the shank within the spindle bore.

### DETAILED DESCRIPTION OF THE ILLUSTRATED EMBODIMENT

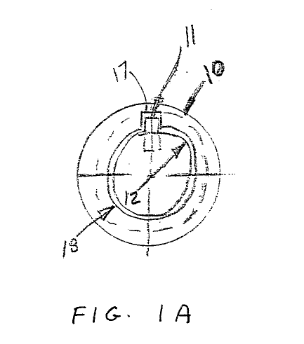

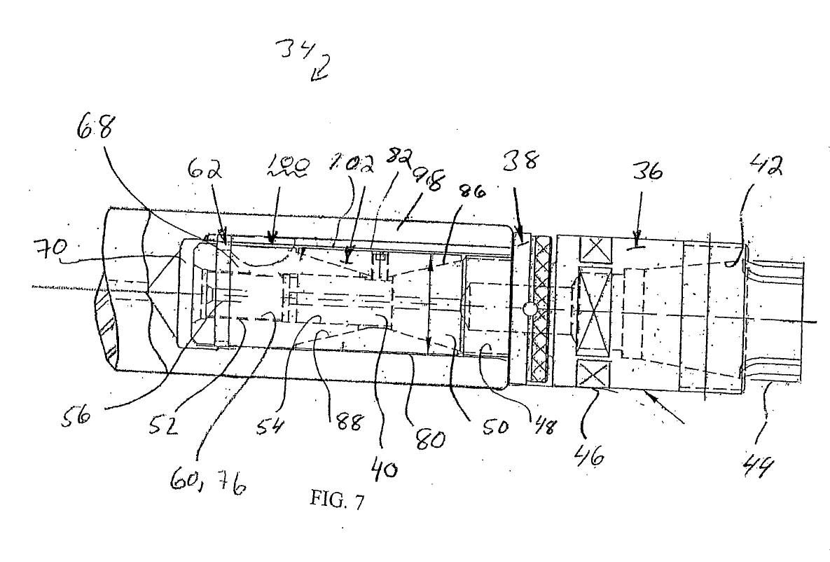

FIG. 2 illustrates a side elevation view of elements of the present invention. The tool holder generally shown as 34 comprises a work holding system—one type being a chuck 36, an adjusting nut 38, and a shank 40. A tool 44 fits in a work holding system (collet, taper split sleeve, end mill holder bore and the like) 36 wherein collet 42 secures the tool 44 in a standard tool holding bore for processing as generally known in the art. The presetting nut 38 includes six flats 46 which match with a tightening tool (not shown) to rotate holder body 36 into spindle bore 98 (FIG. 7). The adjusting nut 38 further includes a collapsible threaded-leaf (not shown) which when tightened secures holder body 36 in its lateral position in relation to spindle 98 (FIG. 7) front end as will be discussed.

The shank 40, in turn, comprises a first shank portion 50, a second shank portion 52 and a body 54 wherein the body 54 separates the first shank portion 50 and the second shank portion 52. In an embodiment, the first shank portion 50 has a larger surface area than the second shank portion 52 and the body 54, wherein the second shank portion 52 and the body 54 have similar configurations. Although the first shank portion 50 is larger than the second shank portion 52 and the body 54, the components of the shank 40 are aligned coaxially with each other. Consequently, the first shank portion 50, the second shank portion 52 and the body 54 include a coolant bore 56 to supply coolant to the tool 44, if required by the process.

The first shank portion 50 extends/tapers downward toward the body 54 at angles with respect to the adjusting nut 38 and the body 54. Additionally, the outer surface at the first shank portion 50 comprises a smooth finish free from interferences and voids. In an embodiment, the first shank portion 50 is configured in a conical shape wherein the angles extending from the threads of adjusting nut 38 are less than or equal to 45 degrees included. In a further embodiment, the angles from the first shank portion 50 extending from the threads of adjusting nut 38 to the body 54 are approximately 15 degrees.

The second shank portion 52, which is oppositely disposed from the first shank portion 50 by the body 54, comprises a straight configuration. The second shank portion 52 includes fasteners 60, such as but not limited to, threads located on the outer surface of the second shank portion 52. In an embodiment, the threads are fine pitched threads having 20-40 threads per inch machined on the outer surface and surrounding the second shank portion 52.

The body 54 also comprises a straight configuration separating the first shank portion 50 and the second shank portion 52. Accordingly, the length of the shank 40 can be determined by increasing or decreasing length of the body 54. The surface of the body 54 includes a smooth finish free from interferences and voids.

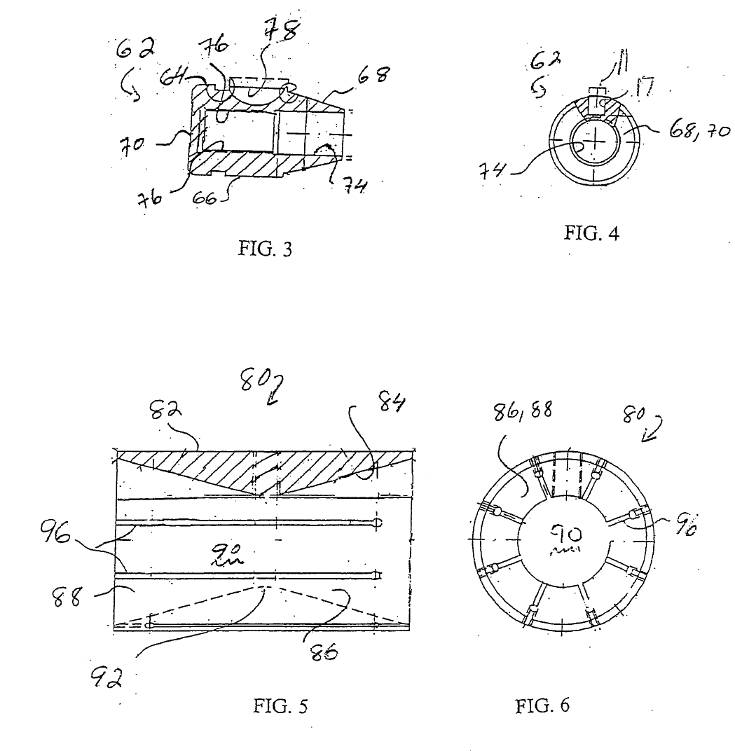

Turning to FIG. 3, an end component 62 is shown in a side elevational view. The end component 62 comprises a top 64, a bottom 66, a first component portion 68 and a second component portion 70 wherein the first component portion 68 extends/tapers downward at angles with respect to the top 64 and bottom 66. In an embodiment, the first component portion 68 is configured in a conical shape wherein the angles are less than or equal to 45 degrees included. In a further embodiment, the angles are approximately 15 degrees. As such, the first component portion 68 is configured in a conical shape which tapers downward in the same configuration as the first shank portion 50. The second component portion 70 may include a retaining ring to prevent removal of the end component 62.

The end component 62 further includes a channel 74 disposed within such that the channel 74 includes fasteners 76 such as threads located on an inner surface of the channel 74. In an embodiment, the fasteners 76 may include fine pitched threads having 20 to 40 threads per inch. The fasteners 76 of the channel 74 for the end component 62 are configured to match the fasteners 60 of the second shank portion 52 as will be discussed. The end component 62 further includes a key 78 configured into the top 64 of the end component 62. Turning to FIG. 4, the end component 62 is shown in a cross-sectional view of FIG. 3 wherein the tapered first component portion 68 is shown. Additionally, the channel 74 assists in alignment and maintaining equal pressure of female and male conical shapes 50, 68, 84, 88.

Referring to FIG. 5, an expansion member 80 is shown in a side elevational view wherein the expansion member 80 includes an outer wall 82 and an inner wall 84. The inner wall 84 extends outward and then inward with respect to the outer wall 82 to form a first expansion portion 86 and a second expansion portion 88. The first expansion portion 86 and the second expansion portion 88 extend/taper downward toward the center 90 of the expansion member 80.

In an embodiment, the first expansion portion 86 and the second expansion portion 88 are configured in conical shapes while positioned in opposite directions with respect to each other. Accordingly, the first expansion portion 86 and the second expansion portion 88 form a frusto-conical like configuration such that the first expansion portion 86 tapers downward and toward the second expansion portion 88 while the second expansion portion 88 tapers downward and toward the first expansion portion 86. As illustrated, however, a spaced member 92 may exist between the first expansion portion 86 and the second expansion portion 88.

The angles forming both the first expansion portion 86 and the second expansion portion 88 with respect to the outer wall 82 of the expansion member 80 are less than 45 degrees included. In an embodiment, the angles are approximately 15 degrees. Accordingly, the configuration of the first expansion portion 86 is the same as the configuration of the first shank portion 50 while the configuration of the second expansion portion 88 is the same as the first component portion 68. As shown, the first expansion portion 86 and the second expansion portion 88 are hollow forming an open space through the expansion member 80.

The expansion member 80 further includes a plurality of slots 96 positioned through the outer wall 82 and the inner wall 84. The plurality of slots 96 are positioned in an alternating sequence starting from the first expansion portion 86 and the second expansion portion 88 respectively. As illustrated, the plurality of slots 96 do not extend all the way across the expansion member 80.

Turning to FIG. 6, the expansion member 80 is shown in a cross-sectional view of FIG. 5 illustrating the plurality of slots 96 extending through either the first expansion portion 86 or the second expansion portion 88. Additionally, the first expansion portion 86 or the second expansion portion 88 are shown tapering toward the center 90 of the expansion member 80.

Referring to FIG. 7, the assembly of tool holder 34 of the present disclosure is shown with the shank 40 positioned within the spindle bore 98. During use, the operator positions the expansion member 80 around the shank 40. In particular, the expansion member 80 slides over the body 54 and first shank portion 50 such that the first shank portion 50 nests within the first expansion portion 86 of the expansion member 80. Next, the end component 62 is positioned partially within the expansion member 80 such that the first component portion 68 nests within the second expansion portion 88 of the expansion member 80. Since the first expansion member 80 and the second expansion member 88 are oppositely positioned in the cone configuration, the first shank portion 50 and the first component portion 68 do not contact each other.

The end component 62 is then positioned around the second shank portion 52 wherein the internal fasteners 76 (FIG. 3) of the end component 62 mate with the external fasteners 60 (FIG. 2) of the second shank portion 52. As the end component 62 advances along the threads of the second shank portion 52 toward the body 54, the first component portion 68 further nests within the second expansion portion 88. Once the end component 62 is fully engaged with the shank 40, the expansion member 80 covers the first shank portion 50, the second shank portion 52 and the body 54.

Next, the chuck 36 and shank 40 insert into the spindle bore 98. Then, an operator inserts the tool 44 into the collet 42 and tightens the tool 44 within the collet 42. Next, the operator inserts a fastener tool, such as a wrench, in the flats 46 of the body 36. Once the fastener is attached, the operator rotates the fastener in order to tighten the body 36 which connects with the spindle bore 98 when the shank 40 is inserted into the spindle bore 98. As shown, a gap 100 exists between the spindle bore 98 and the outer wall 82 of the expansion member 80. This gap 100 may include a range from 0.0002 inches up to and including 0.001 inches. The first shank portion 50, the first component portion 68 and the expansion member 80 are configured to eliminate the effect of the gap 100.

When the operator rotates/fastens the body 36, force is applied to the opposing first shank portion 50 and the first component portion 68. Since the first shank portion 50 and the second shank portion 52 are fixed within the spindle bore 98, the force is applied to the expansion member 80 via the first expansion portion 86 and the second expansion portion 88. The applied force results in an outward force against the first expansion member 80 and the second expansion member 88 to force the plurality of slots 96 to expand against an inner spindle wall 102 of the spindle bore 98. Accordingly, the expansion member 80 expands as the shank 40 is tightened within the spindle bore 98. In other words, as the body 36 pushes the first shank portion 50 and the first component portion 68, the force is applied substantially equally in all directions to the expansion member 80. Accordingly, the slots 96 allow the expansion member 80 to uniformly contact the inner spindle wall 102 of the spindle bore 98.

With the uniform contact applied to the spindle bore 98, the shank 40 is fixed within the spindle bore 98. Thus, the shank 40 does not move within the spindle bore 98 during rotation of the spindle bore 98. Accordingly, the axis of rotation of the shank 40 and body 36 has the same center line axis of rotation of the spindle bore 98. Thus, the tool 44 rotates co-axially with the spindle bore 98 preventing run-out of the tool 44. As such, the first shank portion 50, the first component portion 68, the first expansion portion 86 and the second expansion portion 88 are configured to optimize the expansion of the expansion member 80 against the inner spindle wall 102 of the spindle bore 98. After the slots 96 expand and contact the inner spindle wall 102, the spindle bore 98 is activated to rotate the tool 44 in the same axis of rotation as the spindle bore 98.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected by the following claims.

I claim:

1. A tool holder device, comprising:
a shank, the shank having a first shank portion and a second shank portion;
an end component, the end component having a first component portion and a second component portion, the end component being removably engaged with the shank; and
an expansion member, the expansion member being configured to surround the first shank portion and the first component portion wherein the expansion member expands as the shank is engaged with the end component.

2. The tool holder device of claim 1, further comprising a plurality of slots positioned on the expansion member.

3. The tool holder device of claim 1, wherein the shank comprises a body, the body separating the first shank portion and the second shank portion.

4. The tool holder device of claim 3, wherein the body separates the first shank portion and the first component portion.

5. The tool holder device of claim 1, wherein the first shank portion and the first component portion are conical shaped.

6. The tool holder device of claim 1, wherein the first shank portion and the first component portion taper toward the body.

7. The tool holder device of claim 1, wherein the expansion member comprises a first expansion portion and a second expansion portion.

8. The tool holder device of claim 7, wherein the first expansion portion and the second expansion portion are conical shaped tapering toward each other.

9. The tool holder device of claim 7, wherein the first shank portion nests within the first expansion portion.

10. The tool holder device of claim 7, wherein the first component portion nests within the second expansion portion.

11. A tool holder device which fastens a tool in the centerline axis of rotation of a spindle, comprising:
a shank, the shank removably connected to the spindle, the shank having a first shank portion, a second shank portion and a body, the body separating the first shank portion and the second shank portion such that the first shank portion and the second shank portion taper toward the body;
an end component, the end component having a first component portion and a second component portion, the end component being removably engaged with the second shank portion; and
an expansion member, the expansion member comprising a first expansion portion and a second expansion portion wherein the first shank portion nests within the first expansion portion and the first component portion nests within the second expansion portion such that the expansion member expands against the spindle as the shank is engaged with the end component to fasten the tool in the centerline axis of rotation of the spindle.

12. The tool holder device of claim 11, wherein the first shank portion and the first component portion are conical shaped.

13. The tool holder device of claim 11, wherein the body separates the first shank portion and the first component portion.

14. The tool holder device of claim 11, wherein the first component portion tapers toward the body.

15. The tool holder device of claim 11, wherein the first expansion portion and the second expansion portion are conical shaped tapering toward each other.

16. The tool holder device of claim 11, further comprising a plurality of slots positioned on the expansion member.

17. The tool holder device of claim 16, wherein the plurality of slots are positioned in an alternating sequence from the first expansion portion and the second expansion portion.

18. A method of fastening a tool, comprising:
positioning an expansion member around a shank;
positioning an end component partially within the expansion member;
connecting the end component to the shank;
inserting the shank within a spindle bore; and
expanding the expansion member against the spindle bore to secure the shank within the spindle bore.

19. The method of fastening according to claim 18, wherein positioning the expansion member comprises nesting a first shank portion of the shank within a first expansion portion of the expansion member.

20. The method of fastening according to claim 19, wherein inserting the shank into the spindle bore comprises contacting the first shank component against the first expansion portion to force the first expansion portion to expand outward.

21. The method of fastening according to claim 18, wherein positioning the end component comprises nesting a first component portion of the end component within a second expansion portion of the expansion member.

22. The method of fastening according to claim 21, wherein inserting the shank into the spindle bore comprises contacting the first component portion against the second expansion portion to force the second expansion portion to expand outward.

23. The method of fastening according to claim 18, further comprising positioning a plurality of slots on the expansion member to assist in expanding the expansion member against the spindle bore.

24. The method of fastening according to claim 23, wherein positioning the plurality of slots comprises sequencing in an alternating pattern the plurality of slots with respect to the first expansion portion and the second expansion portion.
